(19) United States
(12) Patent Application Publication
(10) Pub. No.: US 2002/0015193 A1
(43) Pub. Date: Feb. 7, 2002

(54) Illumination device, image sensor having the illumination device, image reading apparatus and information processing system using the image sensor

(76) Inventor: Masami Tabata, Kanagawa (JP)

Correspondence Address: MORGAN & FINNEGAN, L.L.P., 345 PARK AVENUE, NEW YORK, NY, 10154, US

(21) Appl. No.: 09/867,872

(22) Filed: May 30, 2001

(30) Foreign Application Priority Data
May 30, 2000 (JP) 2000-160226

(51) Int. Cl. H04N 1/04

(52) U.S. Cl. 358/475; 358/474

(57) ABSTRACT

This invention has as its object to provide an illumination device which has excellent performance and characteristics, and can attain a cost reduction, size reduction, and the like, an image sensor having the illumination device, and an image reading apparatus and information processing system using the image sensor. To achieve this object, the illumination device has a light source and a light guide member having an entrance surface for receiving light coming from the light source, an exit surface for outputting light in an illumination direction, and a diffusion region for reflecting and/or diffusing an incoming light beam across the longitudinal direction.

### FIELD OF THE INVENTION

The present invention relates to an illumination device using a light guide member, an image sensor having the illumination device, and an image reading apparatus and information processing system using the image sensor.

### BACKGROUND OF THE INVENTION

Conventionally, as an illumination device for a reader of an information processing apparatus such as a facsimile apparatus, digital copying machine, or the like, a discharge tube such as a fluorescent tube, an LED array including a large number of LED chips, or a rod-like illumination device in which an LED chip is arranged at an end portion of a light guide member is used.

In recent years, since facsimile apparatuses and personal computers have prevailed increasingly, and scanners as their peripheral devices are used in homes, products having a smaller size and lower price are required. To meet such requirement, a rod-like illumination device which uses an LED chip as a light source, and a light guide member that can reduce the number of LED chips is prevalently used.

FIG. 15 is a schematic perspective view showing an example of the conventional rod-like illumination device. Referring to FIG. 15, reference numerals 21, 22, and 23 denote LEDs for respectively emitting red, green, and blue light beams; 10, a light guide member made up of a transmission member; 11, a diffusion region for extracting light beams, which travel inside the light guide member 10 by, e.g., reflection, scattering, or the like, outside the light guide member 10; 12, an entrance surface where light beams emitted by an LED light source 20 enters the light guide member 10; and 13, an exit surface for outputting light in the illumination direction.

The LEDs 21, 22, and 23 are offset from a normal to the diffusion region 11 to prevent high illuminance near the light source, i.e., an ununiform illuminance distribution (Japanese Patent Laid-Open No. 6-217084). Light beams, which are emitted by the LEDs 21, 22, and 23 and enter the light guide member 10 via the entrance surface 12 of the light guide member 10, travel inside the light guide member 10 while being totally reflected by its inner surfaces. When the light beam hit the diffusion region 11 after some reflections, they are reflected or diffused there, and at least some light components of those light beams are externally output from the exit surface 13 that faces the diffusion region 11, thus illuminating a desired position.

However, in such prior art, the R, G, and B LEDs as the light source are disposed as close as possible, but cannot be disposed at a single position. Hence, when such illumination device is used as that for a color reader in which the R, G, and B LEDs are independently turned on to color-separate and read document information, the following problems are posed.

FIG. 16A is a sectional view of the LED light source 20 in the conventional illumination device. In FIG. 16A, the surfaces of LEDs 21, 22, and 23 are protected by a light-transmitting resin 26. Light emitted by each LED does not leave the light-transmitting resin 26 at a position slightly separate from that immediately above the LED, since an angle of incidence θₙ the light makes with the interface between the light-transmitting resin and air becomes equal to or larger than a total reflection angle θₕ=ASIN (refractive index of air/refractive index of light-transmitting resin). For this reason, light beams emitted by the R, G, and B LEDs at different positions can only leave the surface of the light-transmitting resin from positions immediately above the corresponding LED positions and their nearby positions.

FIGS. 17A and 17B show a state wherein light beams emitted by the LEDs enter the entrance surface 12 of the light guide member 10 in the conventional illumination device. Light which has entered the entrance surface 12 of the light guide member 10 is refracted due to the difference between the refractive indices of air and the light guide member, and the angle θₙ after entrance becomes equal to or smaller than the total reflection angle θₕ=ASIN.

FIG. 18A shows the light distribution characteristics of the LED before light enters the entrance surface 12, and FIG. 18B shows those of the LED after light has entered the entrance surface 12. After light has entered the entrance surface 12, the light distribution range of the LED becomes extremely smaller than that before entrance. As described above, since light beams emitted by the R, G, and B LEDs enter the entrance surface 12 from different positions, and their light distribution range is narrowed down after light has entered the entrance surface 12, the R, G, and B light beams have extremely different shortest optical paths until they reach the diffusion region.

FIG. 19 shows illuminance distributions on the surface to be illuminated when the R, G, and B LEDs are independently turned on. As can be seen from FIG. 19, the R, G, and B LEDs have different effective illumination start positions on the LED side. Since the total length of the light guide member 10 is set in correspondence with the LED (blue in the prior art) having the longest minimum optical path, it becomes larger than that of a monochrome illumination device.

### SUMMARY OF THE INVENTION

The present invention has been made in consideration of the above situation, and has as its object to provide an illumination device which has excellent performance and characteristics, and can attain a cost reduction, size reduction, and the like, an image sensor having the illumination device, and an image reading apparatus and information processing system using the image sensor.

In order to solve the above problems and to achieve the above object, an illumination device according to the present invention is characterized by the following arrangement.

That is, an illumination device which comprises a light source and a light guide member having an entrance surface for receiving light coming from the light source, an exit surface for outputting light in an illumination direction, and a diffusion region for reflecting and/or diffusing an incoming light beam across a longitudinal direction, comprises diffusion means inserted in an optical path of light which is emitted by the light source and enters the entrance surface.

An image sensor of the present invention is characterized by the following arrangement.

That is, an image sensor comprises the aforementioned illumination device, a lens for imaging optical information at a read position, and a photoelectric conversion element for receiving an optical image formed by the lens, and converting the optical image into an electrical signal.

An image reading apparatus of the present invention is characterized by the following arrangement.

That is, an image reading apparatus comprises the aforementioned image sensor, and driving means for changing a relative position between the image sensor and an object to be read.

An information processing system of the present invention is characterized by the following arrangement.

That is, an information processing system comprises the aforementioned image reading apparatus, and an external information processing apparatus for controlling the image reading apparatus.

According to the present invention, since a three-dimensional pattern is formed on the surface of the light-transmitting resin that covers a plurality of LEDs, or the light-transmitting resin contains a scattering agent, the area where light can be externally extracted from the surface of the light-transmitting resin that covers the LEDs can be broadened. In this manner, light beams emitted by LEDs at different positions can be externally output from an identical position.

Since the entrance surface of the light guide member has a light diffusion surface such as a three-dimensionally patterned surface, a light beam emitted by each LED is diffused by the entrance surface, and the light distribution range after entrance is broadened. As a result, the shortest optical path until the diffusion region of the light guide member can be shortened, and the distance from the end portion of the light guide member on the LED side to an effective illumination area can be shortened. In this manner, the longitudinal size of the illumination device can be reduced while assuring a required illumination length.

Other objects and advantages besides those discussed above shall be apparent to those skilled in the art from the description of a preferred embodiment of the invention which follows. In the description, reference is made to accompanying drawings, which form a part hereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

FIGS. 1A and 1B are schematic views of an illumination device according to the first embodiment of the present invention;

FIGS. 2A to 2C are schematic views of an illumination device according to the second embodiment of the present invention;

FIG. 3 is a sectional view of a light source of the illumination device according to the second embodiment of the present invention;

FIG. 4 is a sectional view of a light source of an illumination device according to the third embodiment of the present invention;

FIG. 5 is an enlarged view of the entrance surface of a light guide member of an illumination device according to the fourth embodiment of the present invention;

FIGS. 6A and 6B are views showing a typical example of light rays that enter the entrance surface of the light guide member of the illumination device according to the fourth embodiment of the present invention, and the light distribution characteristics after the light rays have entered the entrance surface of the light guide member;

FIG. 7 is an enlarged view of the entrance surface of a light guide member of an illumination device according to the fifth embodiment of the present invention;

FIG. 8 is a side view of an illumination device according to the sixth embodiment of the present invention;

FIG. 9 is a sectional view of a flatbed scanner as a document reading apparatus using the illumination device of the present invention;

FIG. 10 is a perspective view of an image sensor using the illumination device of the present invention;

FIG. 11 is a sectional view of a flatbed type image sensor using the illumination device of the present invention;

FIG. 12 is a sectional view of a sheetfed type image sensor using the illumination device of the present invention;

FIG. 13 is a schematic view of an image sensor using a reduction lens system to which the illumination device of the present invention is applied;

FIG. 14 is a block diagram for explaining an information processing system using the image sensor which comprises the illumination device of the present invention;

FIG. 15 is a schematic perspective view of a conventional illumination device;

FIGS. 16A and 16B are respectively a sectional view of a light source of the conventional illumination device, and a view showing the reflection state of light;

FIGS. 17A and 17B are respectively an enlarged view of the entrance surface of a light guide member of the conventional illumination device, and a view showing the reflection state of light;

FIGS. 18A and 18B are views showing the light distribution characteristics of a light source before and after light enters the entrance surface of the light guide member of the conventional illumination device; and

FIG. 19 is a graph showing the illuminance distributions in the conventional illumination device.

### DETAILED DESCRIPTION OF THE PREFERRED EMBODIMENTS

Preferred embodiments of the present invention will be described in detail hereinafter with reference to the accompanying drawings.

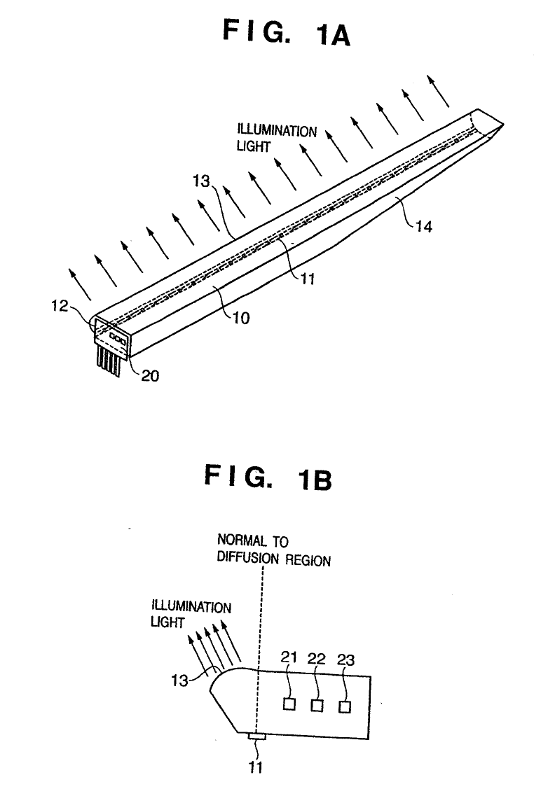

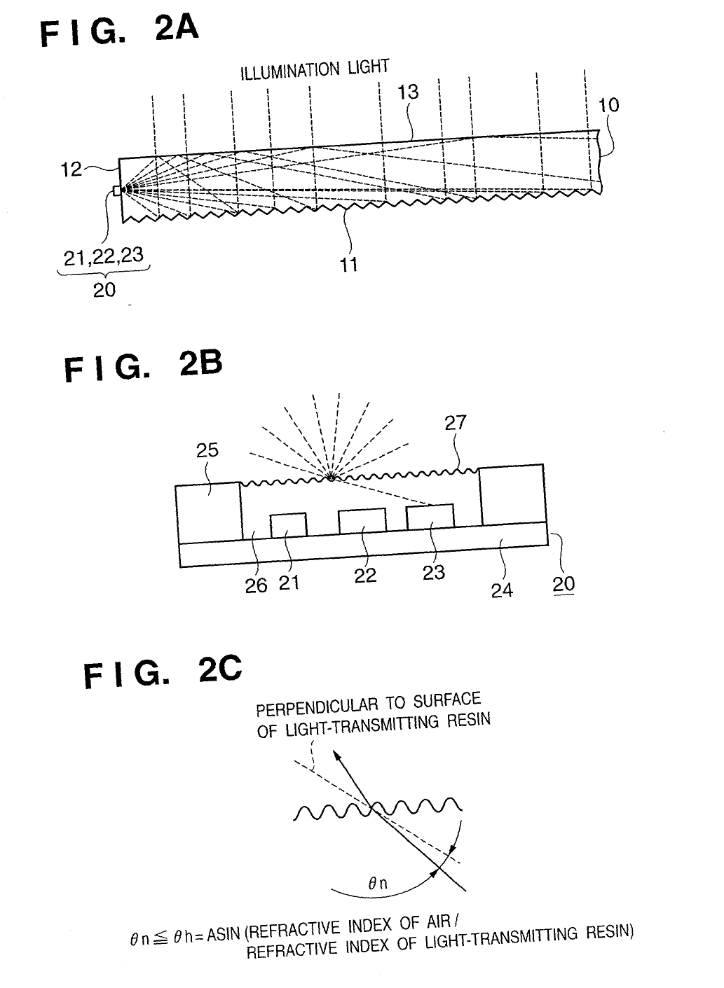

FIGS. 1A to 2C are schematic views for explaining the first embodiment of an illumination device according to the present invention. FIG. 1A is a perspective view showing an illumination device together with its illumination direction, FIG. 1B is a side view of the illumination device viewed from its one end portion, FIG. 2A is a side view of the illumination device together with light rays which travel inside a light guide member 10, and FIGS. 2B and 2C are sectional views of an LED light source of the illumination device.

As shown in FIG. 1A, the illumination device of the present invention comprises a light guide member 10 which is formed of a light-transmitting member, and an LED light source 20. The light guide member 10 is prepared by injection molding of a transparent resin such as an acrylic resin or the like. The light guide member 10 has a diffusion region 11 for linearly reflecting or diffusing light, an entrance surface 12 for receiving light coming from the light source, an exit surface 13 for outputting light in the illumination direction, and a tapered surface 14 that reduces the sectional area of the light guide member 10.

The diffusion region 11 is prepared by forming a sawtooth pattern on a portion of the light guide member 10, and forming a three-dimensional micro-pattern on the sawtooth pattern. When the illuminance must be entirely or locally increased, light-reflecting ink is printed entirely or locally on the sawtooth pattern. The diffusion region 11 need not always be prepared by forming a sawtooth pattern shown in FIG. 1A, but may be prepared by forming a roughened surface on a portion of the light guide member 10 or by simply printing light-reflecting ink on a portion of the light guide member 10.

The exit surface 13 has a lens shape to focus light onto a line to be illuminated. The tapered surface 14 is formed to increase illuminance at a position separate from the LED light source 20, and its sectional area decreases with increasing optical path length from the LED light source 20. In this manner, the exit surface 13 has a function of increasing the amount of light beam that his the diffusion region 11 separated from the LED light source 20, and uniformly illuminating the line to be illuminated as a whole.

In the LED light source 20, a Red-LED 21, Green-LED 22, and Blue-LED 23 which respectively emit three, i.e., red, green, and blue light beams are disposed in turn from the side close to the diffusion region 11 of the light guide member 10 at positions offset from a normal to the diffusion region 11.

FIG. 2A shows light rays that travel inside the light guide member 10. Light beams emitted by the LED light source 20 travel inside the light guide member 10 while repeating total reflection by the inner surfaces of the light guide member. A light beam that hits the diffusion region 11 during traveling is reflected and/or diffused by the diffusion region 11, and some light components are reflected in the illumination direction and emerge from the exit surface 13, thus illuminating the line to be illuminated.

The LED light source 20 of the illumination device of the present invention comprises a lead frame 24 for electrically connecting the Red-LED 21, Green-LED 22, and Blue-LED 23 which respectively emit three, i.e., red, green, and blue light beams, a light-reflecting white resin 25, a light-transmitting resin 26, and a three-dimensional pattern portion 27 formed on the light-transmitting resin 26, as shown in FIG. 2B.

The Red-LED 21 is an InGAlP semiconductor, and the Green- and Blue-LEDs 22 and 23 are GaInN semiconductors. Normally, since GaInN is a thin film formed on a sapphire substrate, and it is readily destroyed by static electricity produced upon handling, static electricity protection elements such as Zenor diodes (not shown in FIG. 2B) are connected in parallel with the Green- and Blue-LEDs 22 and 23.

Upon manufacturing the LED light source 20, the LEDs 21, 22, and 23 are adhered by an adhesive onto the lead frame 24 located at an opening of the white resin 25, and are electrically connected via wires. After that, the light-transmitting resin 26 is applied onto the LEDs 21, 22, and 23 by, e.g., potting or the like to protect the surfaces of the LEDs. The three-dimensional pattern portion 27 can be formed by sandblasting that blows iron or glass powder onto the surface of the light-transmitting resin 26. The width and depth of the three-dimensional pattern can be set at desired values by respectively varying the powder size and pressure of sandblasting.

Light beams coming from the LEDs 21, 22, and 23 are externally output from the surface of the light-transmitting resin 26 via the resin 26. At least some of light components that hit the surface of the light-transmitting resin 26 away from a position immediately above the LED makes an angle of incidence θₙ which is equal to or smaller than a total reflection angle θₕ=ASIN (refractive index of air/refractive index of light-transmitting resin). For this reason, that light is not totally reflected, and can be externally output from the entire surface of the light-transmitting resin 26. In this way, any illuminance drop near the LEDs upon solely turning on the Blue-LED 23 and inputting that light to the entrance surface 12 of the light guide member 10 can be eliminated.

Although the three LEDs are disposed at different positions, light beams coming from the Red-LED 21, Green-LED 22, and Blue-LED 23 emerge from identical positions of the entire surface of the light-transmitting resin 26. Since these light beams enter the entrance surface 12 of the light guide member 10 at identical positions, the Red-LED 21, Green-LED 22, and Blue-LED 23 can have uniform illuminance distribution characteristics. Therefore, color reproduction of an information processing apparatus (e.g., an image reading apparatus or image display apparatus) that uses the illumination device of the present invention can be greatly improved.

In this embodiment, the three-dimensional pattern portion 27 is formed on the surface of the light-transmitting resin 26, but an independent member may be adhered to the surface of the light-transmitting resin 26 by an adhesive or the like to obtain a three-dimensional pattern portion.

The second embodiment of the present invention will be described below.

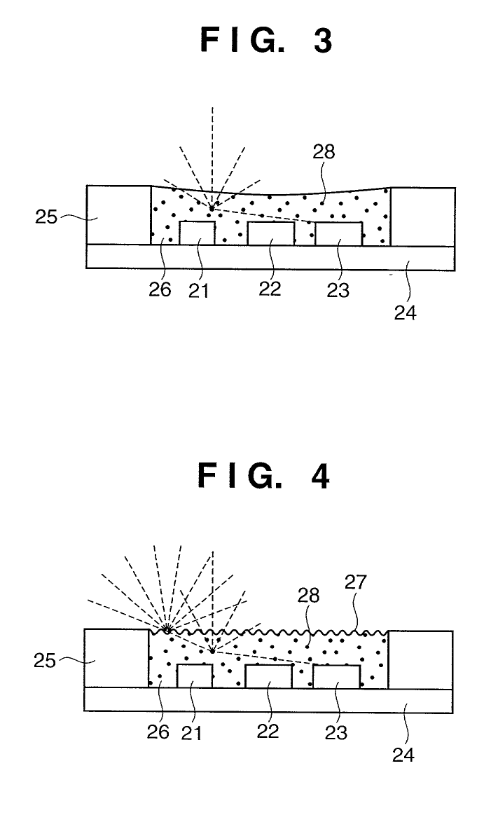

FIG. 3 shows the second embodiment, in which the light-transmitting resin 26 contains scattering agent particles 28 such as silica or the like. In this case, the same effect as in the first embodiment can be obtained.

That is, when light emitted by a given LED reaches the surface of the light-transmitting resin 26 at a position separate from that immediately above the LED, and makes an angle of incidence θₙ which is equal to or larger than a total reflection angle θₕ, that light is not externally output since it is totally reflected. However, since the light-transmitting resin 26 contains the scattering agent particles 28, the light is scattered by the scattering agent particles 28 before it reaches the surface of the light-transmitting resin 26. As a result, at least some light components become light that makes θₕ=ASIN (refractive index of air/refractive index of light-transmitting resin) or less, and can be externally output without being totally reflected.

FIG. 4 shows the third embodiment. In this embodiment, both the three-dimensional pattern portion 27 formed on the surface of the light-transmitting resin 26 in the first embodiment, and the scattering agent particles 28 contained in the light-transmitting-resin 26 in the second embodiment are combined. In this way, using both the three-dimensional pattern portion 27 and scattering agent 28, still higher effects are obtained.

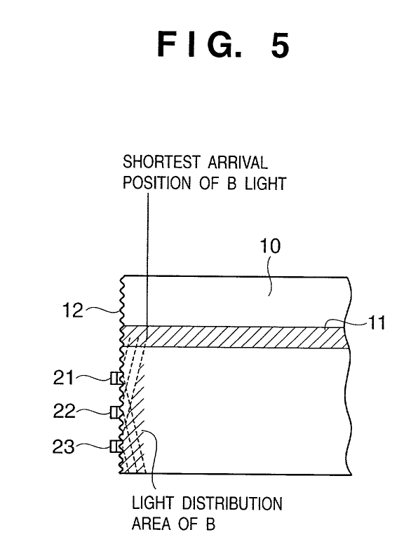

FIG. 5 shows the fourth embodiment. In this embodiment, a three-dimensional micro-pattern is formed on the entrance surface 12 of the light guide member 10. The three-dimensional micro-pattern can be formed by roughening a portion corresponding to the entrance surface 12 in metal molds of the light guide member 10 by sandblasting that brows iron or glass powder. Alternatively, the three-dimensional micro-pattern may be formed by directly roughening a molded product of the light guide member 10 by sandblasting or the like.

The width and depth of the three-dimensional micro-pattern can be set at desired values by respectively varying the powder size and pressure of sandblasting. In this case, both the width and depth of the three-dimensional micro-pattern are appropriately set at around 0.1 to 10 μm near the emission wavelength of the light source.

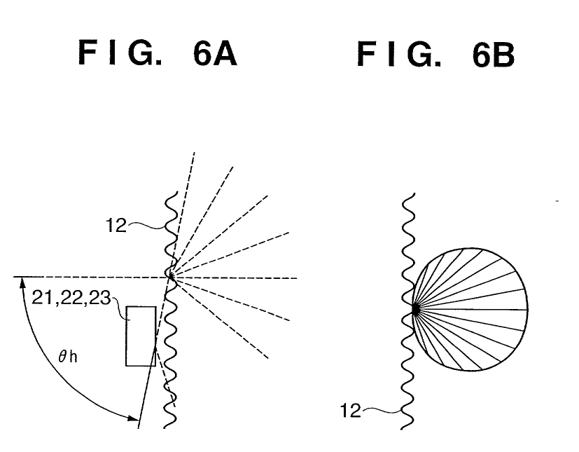

FIGS. 6A and 6B respectively show a typical example of light rays that come from the LEDs and enter the entrance surface 12, and light distribution characteristics after light rays have entered the entrance surface 12. Since the light rays are scattered by the three-dimensional micro-pattern on the entrance surface 12, broad light distribution characteristics like those before entrance can be obtained without narrowing down the light distribution range even after they have entered the entrance surface 12. In this way, the shortest optical path from the entrance surface 12 to the diffusion region 11 of light emitted by each LED can be shortened, and the shortest optical path differences among R, G, and B light beams can be reduced.

Therefore, differences among R, G, and B illuminance distributions due to different LED positions can be reduced. For this reason, a short rise time can be assured in R, G, and B illuminance characteristics from the end portion of the light guide member 10. Especially, in an illumination device in which light-reflecting ink must be printed on a portion of the diffusion region 11 near the LED for the purpose of increasing the illuminance near the LED, if no such ink is printed, substantially the same illuminance distribution as that of the aforementioned device can be obtained, and a cost reduction of the illuminance device can be achieved. Also, the total length of the illumination device can be shortened, and such device can contribute to downsizing of a product using the illumination device of the present invention.

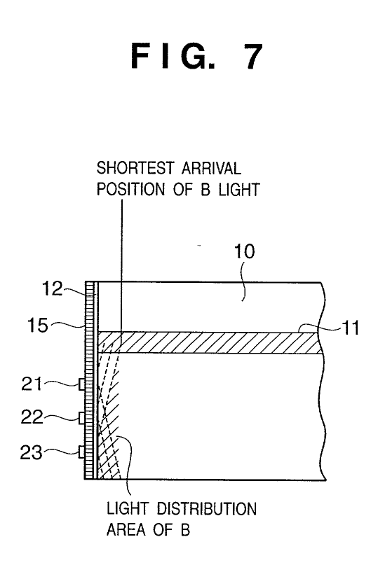

FIG. 7 shows the fifth embodiment. In this example, a diffusion plate 15 is adhered to the entrance surface 12. With the diffusion plate 15, the same effect as that obtained when a three-dimensional pattern is formed on the entrance surface 12 can be obtained.

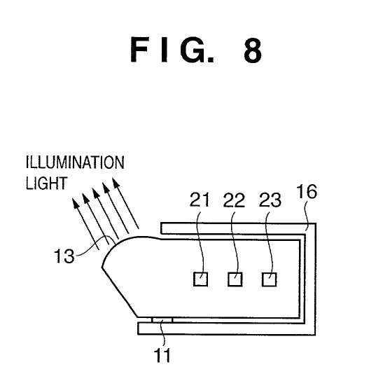

FIG. 8 shows the sixth embodiment. In this embodiment, a portion of the light guide member 10 except for the exit surface 13 in the fourth and fifth embodiments is covered by a light-reflecting cover 16.

As described above, in the fourth and fifth embodiments, the light distribution range of light that has entered the entrance surface 12 is broadened by forming a three-dimensional pattern on the entrance surface 12. In this case, some light components make an angle of incidence θₙ which is equal to or smaller than a total reflection angle θₕ=ASIN with the inner surface of the light guide member 10 other than the exit surface 13, and do not contribute to illumination light output externally. When the light guide member 10 is covered by the light-reflecting cover 16 except for the exit surface 1, light components that leak from the side surfaces of the light guide member 10 except for the exit surface are reflected by the light-reflecting cover 16. Since such light components return inside the light guide member 10 again, the light use efficiency can be improved, and the illuminance on the line to be illuminated can be increased. The light-reflecting cover 16 can be easily prepared by injection molding of a white resin. However, the cover need not always be adopted. That is, by covering at least a portion of the light guide member 10 by a member such as a reflecting sheet or the like that can reflect light, an increase in illuminance can be expected.

The light source in the first to sixth embodiments described above uses one each R, G, and B LEDs. However, the present invention is not limited to such specific light source. For example, the present invention can be applied to a light source which uses a plurality of single-color LEDs (e.g., green) or a light source that uses a plurality of two-color LEDs. Also, a halogen lamp, fluorescent lamp, EL, or the like may be used as the light source. Furthermore, the present invention can be applied to a light source which is set on a normal to the diffusion region 11 of the light guide member 10, and the same effects as those in the above embodiments can be obtained.

A flatbed scanner as an image reading apparatus using the illumination device of the present invention will be described below using the drawings.

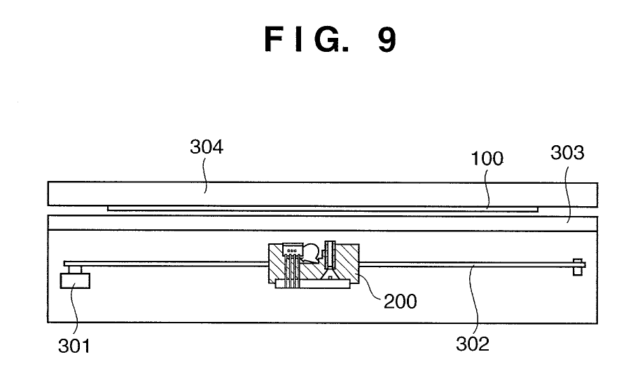

FIG. 9 shows an example of a flatbed scanner according to the present invention. Referring to FIG. 9, reference numeral 200 denotes an image sensor for converting optical information of a document into an electrical signal; 301, a driving motor for moving the image sensor 200 in a sub-scan direction; 302, a driving belt; 303, a glass plate for regulating the position of a document; and 304, a document pressing plate for pressing a document against the glass plate.

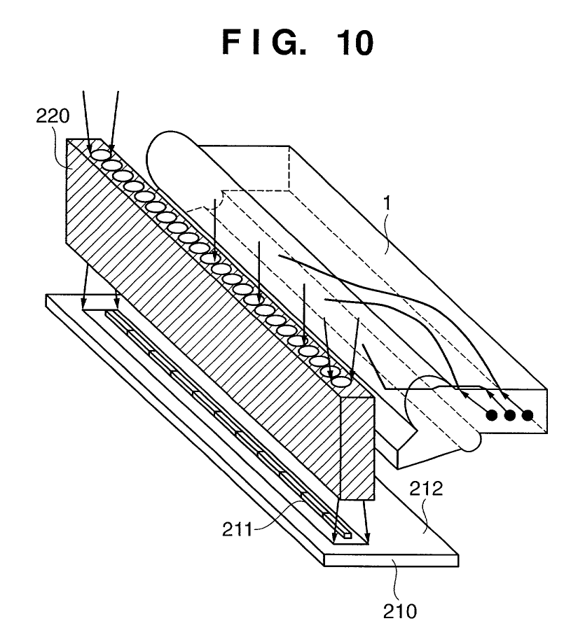

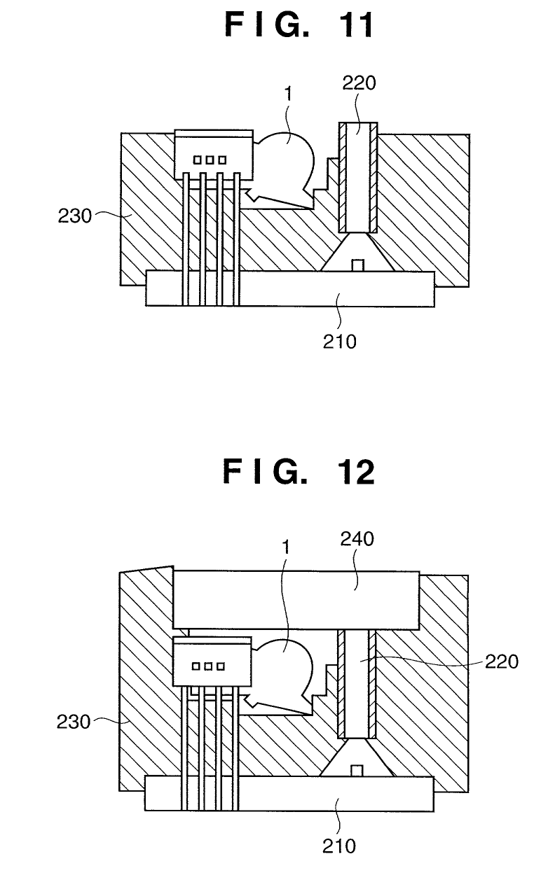

FIG. 10 is a perspective view of the image sensor 200, and FIG. 11 is a sectional view thereof. Referring to FIGS. 10 and 11, the image sensor 200 comprises a sensor array 210 formed by accurately arranging a plurality of linear photoelectric conversion elements 211 in a line on, e.g., a glass epoxy sensor substrate 212 in correspondence with the length of the document to be read, a lens array 220 consisting of a plurality of lens elements, an illumination device 1, and a frame 230 for holding them at predetermined positions.

Upon reading a document image, a document 100 is selectively and sequentially illuminated with three, i.e., red, green, and blue light beams coming from the illumination device 1 incorporated in the image sensor 200, while moving the image sensor 200 in the sub-scan direction. Three pieces of optical information (R, G, and B) of the document form images on the photoelectric conversion elements 211 via the lens array 220, and the photoelectric conversion elements 211 convert the three pieces of optical information (R, G, and B) into electrical signals and send them to a system, thus reading the entire document.

The manufacturing method will be explained below. The illumination device 1 and lens array 220 are inserted and adhered to predetermined grooves formed on the frame 230. In this way, the illumination device 1 and lens array 220 are aligned and fixed in the widthwise and longitudinal directions, and a desired illumination position can be correctly irradiated with light. Therefore, an image can be formed in focus over the total length of the lens array 220. The sensor array 210 is fitted into the frame 230, and is fixed by an adhesive or caulking a portion of the frame. Electrical contacts between lead lines of the illumination device and the sensor substrate 212 are achieved by soldering or the like, thus completing the image sensor.

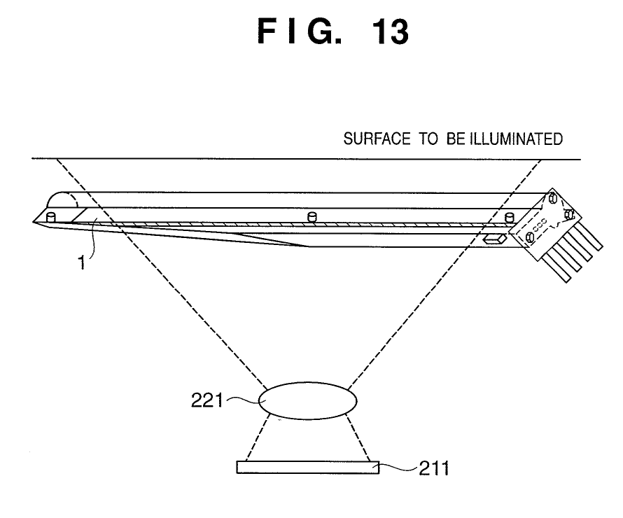

FIG. 12 is a sectional view of a sheetfed type image sensor that reads an image while moving a document. In a document reading apparatus of this type, a cover glass 240 that holds a document is adhered to the frame 230, and the illumination device of the present invention can be applied to the image sensor of this type.

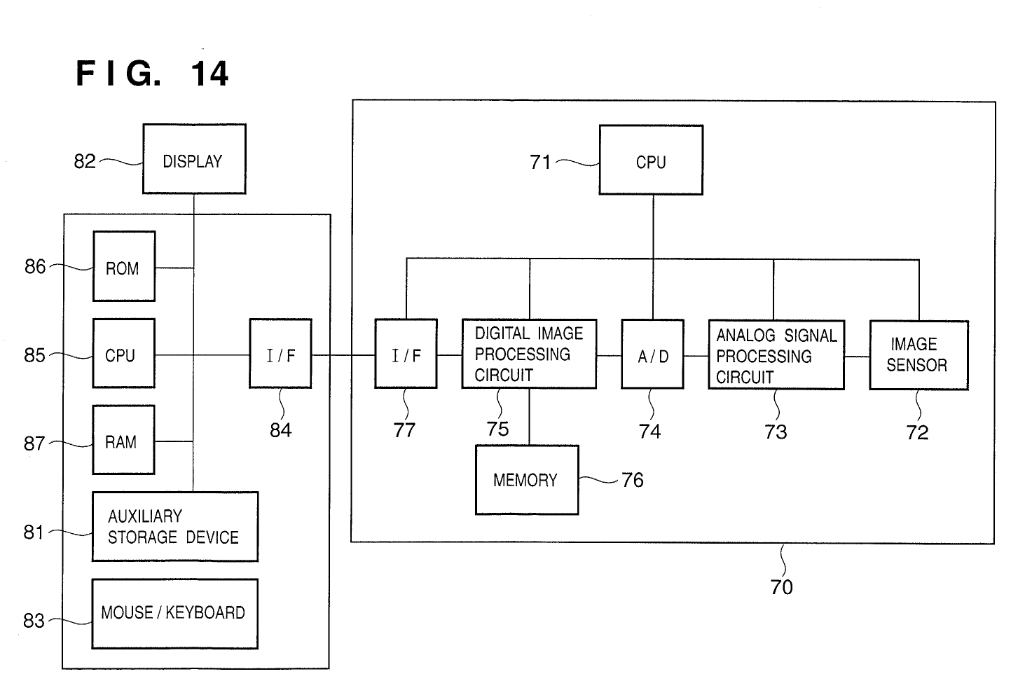

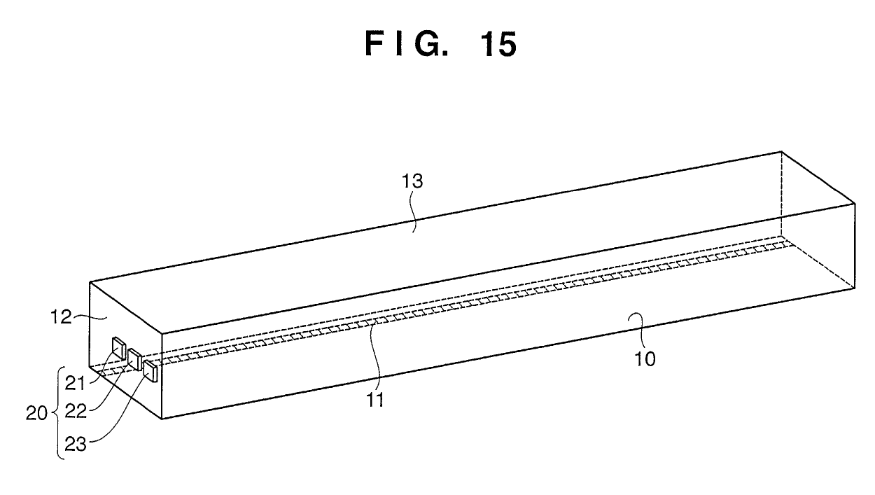

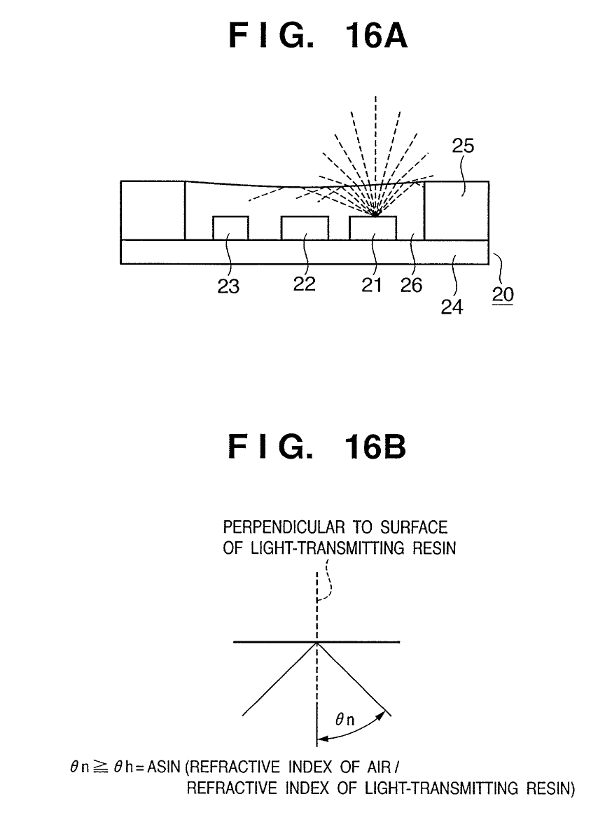

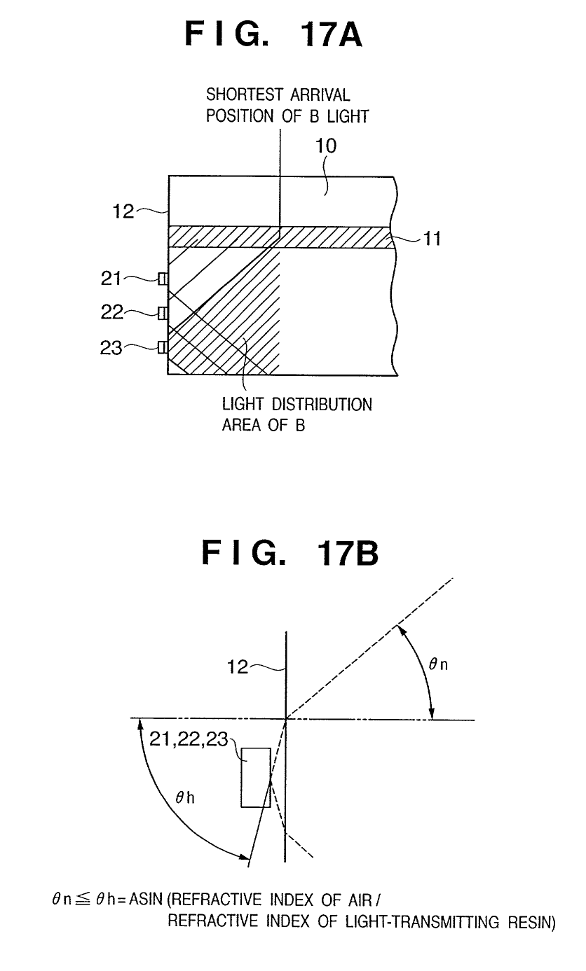

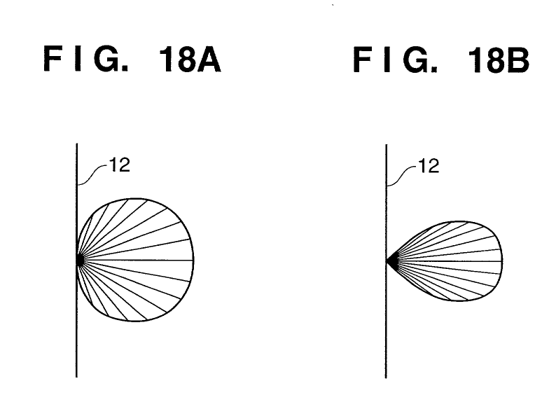

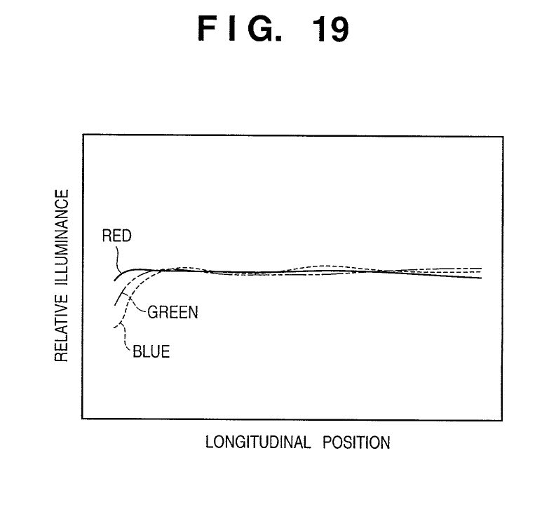

The present invention is not limited to the aforementioned apparatus that uses an equal-magnification lens system. For example, as shown in FIG. 13 that shows another image sensor to which the illumination device of the present invention is applied, the illumination device of the present invention can be applied to an apparatus which uses a reduction lens 221 that projects an image of a document illuminated by the illumination device onto photoelectric conversion elements 211 such as CCDs or the like in a reduced scale.

FIG. 14 shows an example of an information processing system using the image sensor described in the above embodiments. An example of the arrangement of a system which is built by connecting an image reading apparatus 70 that incorporates an image sensor 72 to a personal computer 80, and outputs read image information to the computer or a network will be explained below.

Referring to FIG. 14, reference numeral 71 denotes a CPU as a first control means for controlling the overall image reading apparatus 70; 72, an image sensor as a reading unit which comprises a light source, sensor, and the like, as described above, and converts a document image into an image signal; and 73, an analog signal processing circuit for executing an analog process such as gain adjustment or the like of an analog image signal output from the image sensor 72.

Reference numeral 74 denotes an A/D converter for converting the output from the analog signal processing circuit 73 into a digital signal; 75, an image processing circuit for executing image processes such as shading correction, gamma conversion, a zoom process, and the like of the output data from the A/D converter 74 using a memory 76; and 77, an interface for externally outputting digital image data that has undergone the image processes of the image processing circuit 75.

The interface 77 complies with specifications such as SCSI, Bi-Centronics, or the like, which is normally used in a personal computer, and is connected to the personal computer 80. The analog signal processing circuit 73, A/D converter 74, image processing circuit 75, and memory 76 construct a signal processing means.

The personal computer 80 as a second control means has a magnetooptical disk drive, floppy disk drive, or the like as an external storage device or auxiliary storage device 81. Furthermore, in FIG. 14, reference numeral 82 denotes a display for displaying processes on the personal computer 80; and 83, a mouse/keyboard used to input commands or the like to the personal computer. Reference numeral 84 denotes an interface for controlling exchange of data, commands, and status information of the image reading apparatus between the personal computer and image reading apparatus.

The personal computer 80 can input a read instruction to the image reading apparatus via the mouse/keyboard 83. When a read instruction is input by the muse/keyboard 83, a CPU 85 sends a read command to the image reading apparatus via the interface 84. The personal computer 80 then controls the image reading apparatus in accordance with control program information stored in a ROM 86. Note that the control program may be loaded, into the personal computer 80, from a storage medium such as a magnetooptical disk, floppy disk, or the like, which is loaded into the auxiliary storage device 81 and stores the program, and may be executed by the CPU 85.

Since the aforementioned image sensor 72 is used in the apparatus of the present invention like in this example, a practical image reading apparatus can be realized.

As described above, according to the above embodiments, a low-cost, compact illumination device having uniform illumination distribution characteristics can be provided. Also, according to the above embodiments, an image sensor, image reading apparatus, information processing system, and the like, which can read a high-quality image, can be provided.

The present invention is not limited to the above embodiments and various changes and modifications can be made within the spirit and scope of the present invention. Therefore, to apprise the public of the scope of the present invention the following claims are made.

What is claimed is:

1. An illumination device which comprises a light source and a light guide member having an entrance surface for receiving light coming from the light source, an exit surface for outputting light in an illumination direction, and a diffusion region for reflecting and/or diffusing an incoming light beam across a longitudinal direction, comprising diffusion means inserted in an optical path of light which is emitted by the light source and enters the entrance surface.

2. The device according to claim 1, wherein said device comprises a plurality of light sources, and said diffusion means is common to light beams coming from the plurality of light beams.

3. The device according to claim 1, wherein said diffusion means comprises a light diffusion surface formed on the entrance surface.

4. The device according to claim 1, wherein said diffusion means comprises a three-dimensionally patterned surface formed on the entrance surface.

5. The device according to claim 1, wherein said diffusion means comprises a three-dimensionally patterned surface formed on a surface of a resin which covers the light source.

6. The device according to claim 1, wherein said diffusion means comprises a scattering agent contained in a resin that covers the light source.

7. The device according to claim 2, wherein the plurality of light sources are integrally packaged.

8. The device according to claim 2, wherein the plurality of light sources comprise LEDs.

9. The device according to claim 8, wherein the plurality of LEDs have different emission wavelengths.

10. The device according to claim 9, wherein the plurality of LEDs respectively have red, green, and blue emission wavelengths.

11. An image sensor comprising an illumination device cited in claim 1, a lens for imaging optical information at a read position, and a photoelectric conversion element for receiving an optical image formed by said lens, and converting the optical image into an electrical signal.

12. An image reading apparatus comprising an image sensor cited in claim 11, and driving means for changing a relative position between said image sensor and an object to be read.

13. An information processing system comprising an image reading apparatus cited in claim 12, and an external information processing apparatus for controlling said image reading apparatus.
